(19) United States
(12) Patent Application Publication
(10) Pub. No.: US 2014/0316732 A1
(43) Pub. Date: Oct. 23, 2014

(54) QUALITY CONTROL SYSTEM, METHOD AND COMPUTER READABLE MEDIUM FOR USE WITH BIOLOGICAL/ENVIRONMENTAL DIAGNOSTIC TEST DEVICES, USERS AND CONSUMABLES

(71) Applicant: FIO CORPORATION, Toronto (CA)

(72) Inventor: François Dupoteau, Toronto (CA)

(73) Assignee: FIO CORPORATION, Toronto (CA)

(21) Appl. No.: 14/359,068

(22) PCT Filed: Nov. 19, 2012
(86) PCT No.: PCT/CA2012/001066

§ 371 Date: May 16, 2014

Related U.S. Application Data
(60) Provisional application No. 61/561,816, filed on Nov. 18, 2011.

(51) Int. Cl. G01N 35/00

(52) U.S. Cl. CPC G01N 35/00
USPC 702/84

(57) ABSTRACT

A quality control (QC) system collects data associated with biological/environmental diagnostic test devices, users and consumables, and identifies corresponding parameters. The system determines when the data are outside the parameters, and then generates corresponding QC improvement data. A database receives and stores the QC improvement data for use in improved QC procedures. A related method and computer readable medium are also disclosed.

### FIELD OF THE INVENTION

The present invention relates generally to quality control systems, methods and computer readable media, and more particularly to a quality control system, method and computer readable medium for use with biological/environmental diagnostic test devices, users and consumables.

### BACKGROUND OF THE INVENTION

In the prior art, the use of rapid diagnostic tests (“RDTs”) may have been restricted and/or limited by inadequate, insufficient and/or lacking quality control (“QC”) and/or QC improvement.

RDTs may be sensitive to and/or affected by temperature, pre-analytical steps, reading errors, and/or storage problems. Most of these parameters may have never been addressed as a global issue, but managed only as separate issues.

What may be needed is a system, method, and/or computer readable medium which enables QC issues to be monitors and/or the overall improvement QC with respect to any RDT device, user and/or consumables.

As an aside, it is here noted that at least some portions of the present disclosure may apply equally well to non-RDT diagnostic tests, and the present invention and disclosures therefore will be appreciated by persons having ordinary skill in the art to extend to include and apply to such subject matter as well.

What may be needed is a system, method and/or computer readable medium which is operable by a service provider who (operating portions thereof for end users) may preferably have expertise in diagnostics, image processing, cellular communications, user interfaces, software development, nano- and polymer chemistry, optics, information science, industrial design, and/or database solutions. The service provider's clinical expertise may preferably include internal medicine and/or infectious disease clinical practice and/or research, diagnostics, regulatory affairs, and/or clinical trials.

Some of Today's Related Challenges

The World Health Organization (“WHO”) may recommend that all cases of presumptive malaria be confirmed with a diagnostic test, yet most fevers may not receive proper diagnosis before treatment. Health workers in malaria endemic regions may often assume that fever may be caused by malaria and/or may over-treat with anti-malarial medication. Misdiagnosis may increase morbidity and/or mortality. Overtreatment may increase the risk of drug resistance. Valuable and/or limited health resources may thus be wasted.

While the adoption of malaria RDTs may have improved fever management, impact may have been hindered by factors such as quality issues, human error and/or variation of interpretation, some or all of which may decrease accuracy and/or impact quality of care. The same factors may impair the real-world accuracy of non-malaria RDTs as well.

Infectious disease surveillance in developing countries may be compromised by inaccurate, incomplete and/or stale data, perhaps due to the current labour-intensive and/or error-prone manual capture and/or transcription of diagnostic results. This may impair the ability of program managers to make timely, data-driven resource allocation decisions, perhaps leading to inefficient use of current resources.

Overview of Some Ancillary Devices, Systems and/or Methods

Preferably, the system, method and/or computer readable medium according to the present invention may be adapted for use with mobile digital diagnostics integrated with cloud information services, preferably empowering health workers to deliver more accurate diagnoses and/or health program managers to make evidence-based decisions.

Preferably, the system, method and/or computer readable medium according to the present invention may be adapted for use with a smartphone-based, mobile device used by health worker at point of care. Preferably, such a device may: (a) interpret commercially available infectious disease RDTs to improve diagnostic accuracy through digital image analysis; (b) automatically upload real-time, encrypted and/or geo-localized data (e.g., diagnostic, demographic, survey, and/or user workflow data) to a secure database in a cloud-based network; (c) automatically download guidance directives (e.g., clinical protocols, data capture surveys, and/or alerts) from health program managers to health workers, preferably incorporating medical best practices into users' workflow through digital aids; and/or (d) consolidate disparate mobile health programs on a single platform.

For example, such an ancillary device may be a universal reader for existing RDTs. It may enable quality imaging of RDTs at a time of interpretation. Such a device may preferably capture an image of the RDT at the time of interpretation, preferably under controlled composition and/or lighting. The image may preferably be transmitted to a cloud-based system for aggregation and/or later use. The device may also enable accurate RDT processing and/or interpretation at a point of care. It may preferably improve real-world accuracy of RDTs, preferably by facilitating workflow and/or objectively interpreting results. This automated interpretation may preferably be compatible with select malaria RDTs. Other disease targets may include HIV, Dengue, and Hepatitis (among others). The device may also enable digitization of patient information. Users may preferably enter patient information, responses to custom surveys, and/or results of any diagnostic test, preferably via touch screen. The ancillary devices may preferably combine this data with date, time, geo-location and/or other meta-information into a data set for transmission. The device may also enable automatic data aggregation. Data sets may preferably be transmitted to a cloud-based system, preferably in real-time over the local mobile phone network, for use by program managers. The ancillary devices may access medical best practices. Two-way communication with such devices may preferably allow program managers to disseminate current case management guidelines and/or data capture best practices, preferably for integration into everyday workflow. The devices may preferably host applications capable of making case management recommendations, preferably based on diagnostic results and/or patient symptoms.

Still by way of example, the system, method and/or computer readable medium according to the present invention may be adapted for use with one or more ancillary devices which may preferably possess/enable one or more of the following features: may facilitate simultaneous workflow of multiple RDTs; may have a simple user interface with visual cues for step-by-step training and/or operation; all content may be remotely managed through a cloud-based system by program managers; applications/updates to the device software, and/or custom surveys may be downloaded over a mobile phone network; all diagnostic functionality needed by health worker using RDTs may be performed on-board the devices, preferably without any need for cellular communication function; hundreds of patient records may be stored on-board the devices when beyond cell tower range and/or automatically transmitted when coverage may be restored; data records may be encrypted and/or securely transmitted using a secure hypertext transfer protocol (“https”); an automated routine QC check may be performed regularly (e.g., daily); may be run and/or be compatible with select applications on the Android operating system offered by Google Inc. of Mountain View, Calif. and/or on another mobile device operating system; may be battery powered, e.g., affording about four (4) days' operation per charge; hand crank and/or solar charging accessories may be available upon request; may afford GSM communication, e.g., EDGE, 2G and/or 3G; may include SIM card functionality; may enable geo-location via GPS; and/or may have a high-resolution and/or backlit LCD (e.g., a 3.75″ LCD), preferably with a capacitive touch screen.

Such ancillary devices may preferably possess/enable one or more of the following benefits: may put the skill of an expert RDT technician in the hands of minimally-trained health workers; may unify diagnosis and/or data; data from every clinical encounter may be captured for determining resource allocation and/or public health policy; may alert program managers of trend development and/or enable coordinated and/or timely responses; health workers may upgrade their skills through dissemination of best practices in case management; may be compatible in a broad range of point-of-care settings, e.g., clinics, health posts, community outreach, military theatres and/or airports; RDT images and/or aggregate clinical data may be easily used by program managers to quality control health workers and/or may help to identify those in need of remedial training; record keeping may facilitate accountability of resource distribution and/or utilization; and/or may serves as a platform for innovative applications, e.g., therapy guidance, drug authentication, and/or continuing medical education.

Preferably, the system, method and/or computer readable medium according to the present invention may also be adapted for use with a web interface accessible via any Internet-enabled computer by authorized health program manager. Preferably, such an interface may: (a) enable storage, retrieval, and/or analysis of data; (b) enable remote and/or real-time monitoring/management of devices, users' workflows, quality control procedures, and/or data capture; (c) enable real-time dissemination of clinical protocols, surveys, and/or alerts to devices; (d) generate reports; (e) export/import data to/from other databases; and/or (f) enable real-time and/or two-way communication between program managers and/or health workers.

For example, such an ancillary interface may enable web-based access to a cloud-based system. It may enable data aggregation and/or storage. Preferably, data transmitted by devices in the field may be routed in real-time to a cloud-based data warehouse, preferably at least one which may employ enterprise-level data redundancy and/or off-site backup. Preferably, access may be password protected and/or no special IT infrastructure may be required. Such an ancillary interface may enable real-time reporting and/or analysis. Preferably, it may analyze data using customized reports (e.g., maps, statistical analyses, and/or graphs) updated regularly (e.g., every fifteen minutes) and/or search the data warehouse for up-to-the-second information. Such an interface may be enable dissemination of best practice guidelines. Preferably, it may be used to control workflow in clinics by transmitting custom surveys, device software updates, and/or medical best practice protocols. Such an interface may also remotely oversee devices and/or users. Preferably, it may send/receive messages and/or transmit alerts to devices in the field. Preferably, it may control quality of health worker performance and/or coordinate interventions, remotely. This interface may afford interoperability with other health information systems. Preferably, it may import and/or export data to and/or from external databases for enhanced access and/or data management. Preferably, it may leverage the latest reporting and/or analytical tools, and/or mobile health applications, e.g., drug authentication, GIS mapping, and/or SMS clinical follow up.

Still by way of example, the system, method and/or computer readable medium according to the present invention may be adapted for use with one or more ancillary interfaces which may preferably possess/enable one or more of the following features: may be web-hosted; may be accessed via an Internet browser (e.g., Internet Explorer, Safari, Firefox, and/or Chrome) on any computer; may not require any software and/or hardware installation; access may be protected through secure login; program managers may distribute accounts to authorized individuals; reports may be exported in multiple formats, e.g., .pdf, .csv, .xlsx, .docx, and/or .xml; advanced search function may enable customized query of database; may be based on more than forty (40+) search criteria; and/or data transmission and/or format may be compatible with future HL7 compliance and/or interoperability with existing databases and/or electronic medical record systems.

Such ancillary interfaces may preferably possess/enable one or more of the following benefits: may improve timely access by simultaneous authorized users from any Internet-enabled computer to accurate, real-time, and/or epidemiologic data from point-of-care to support program monitoring and/or evaluation, clinical practice quality control, surveillance, and/or data-driven resource allocation decisions; may help to build and manage human capital; may help to identify and/or foster highly productive health workers; may help to provide those in need of remedial training with appropriate materials and/or attention; may help to create and/or improve accountability and/or transparency by gaining and/or affording access to timely and/or auditable records of work performed; and/or may centralize disparate health system strengthening initiatives on one platform.

One or more of the aforementioned features and/or benefits of the ancillary devices and/or interfaces may potentially be achieved and/or improved in tandem with the system, method and/or computer readable medium according to the present invention.

It may be an object according to an aspect of one embodiment of the invention to provide a quality control system, method and/or computer readable medium.

It may be an object according to an aspect of one embodiment of the invention to provide a quality control system, method and/or computer readable medium for use with biological and/or environmental diagnostic test devices, users and/or consumables.

It may be an object according to an aspect of one embodiment of the invention to collect test QC data associated with biological and/or environmental diagnostic test devices, users and/or consumables, and/or to identify corresponding QC parameters.

It may be an object according to an aspect of one embodiment of the invention to determine when test QC data are outside corresponding QC parameters for biological and/or environmental diagnostic test devices, users and/or consumables.

It may be an object according to an aspect of one embodiment of the invention to, when test QC data are outside corresponding QC parameters, generate QC improvement data for biological and/or environmental diagnostic test devices, users and/or consumables.

It may be an object according to an aspect of one embodiment of the invention to a QC database to receive and store QC improvement data for use in improved QC procedures.

It may be an object according to an aspect of one embodiment of the invention to provide QC improvement data for use in improved QC procedures.

It may be an object of the invention to obviate and/or mitigate one or more of the above mentioned disadvantages and/or problems associated with the prior art, and/or to achieve one or more of the aforementioned objects of the invention.

### SUMMARY OF THE INVENTION

According to the invention, there is disclosed a quality control (QC) system for use with one or more biological and/or environmental diagnostic test devices, and one or more users and/or consumables. The system includes a QC data subsystem, a QC analysis subsystem, a QC improvement subsystem, and a QC database. The QC data subsystem collects, from the test devices, test QC data associated with at least one of the test devices, the users and the consumables. For each respective one of the test QC data, the QC data subsystem identifies one or more corresponding QC parameters based on the aforesaid at least one. The QC analysis subsystem determines when one or more of the test QC data are outside the corresponding QC parameters. When the one or more of the test QC data are outside the corresponding QC parameters, the QC improvement subsystem generates QC improvement data associated with the aforesaid at least one. The QC database receives and stores the QC improvement data for use in improved QC procedures associated with the aforesaid at least one.

According to an aspect of one preferred embodiment of the invention, the QC database may preferably, but need not necessarily, be stored remotely from the test devices.

According to an aspect of one preferred embodiment of the invention, at least part of the QC data subsystem, the QC analysis subsystem, and/or the QC improvement subsystem may preferably, but need not necessarily, be located remotely from the test devices.

According to an aspect of one preferred embodiment of the invention, the QC data subsystem may preferably, but need not necessarily, collect the test QC data from and/or associated with: (a) a selected one of the test devices; (b) a selected group of the test devices; and/or (c) all of the test devices.

According to an aspect of one preferred embodiment of the invention, the QC database may preferably, but need not necessarily, be stored onboard a local one of the test devices. The QC data subsystem may preferably, but need not necessarily, collect the test QC data from and/or associated with the aforesaid local one.

According to an aspect of one preferred embodiment of the invention, at least part of the QC data subsystem, the QC analysis subsystem, and/or the QC improvement subsystem may preferably, but need not necessarily, be substantially local with the QC database and/or onboard the aforesaid local one.

According to an aspect of one preferred embodiment of the invention, the QC data subsystem may preferably, but need not necessarily, collect the test QC data from and/or associated with a remote peer group of the test devices.

According to an aspect of one preferred embodiment of the invention, congruent copies of the QC database may preferably, but need not necessarily, be updated and/or stored onboard each of the test devices in the remote peer group.

According to an aspect of one preferred embodiment of the invention, the QC analysis subsystem may preferably but need not necessarily generate, and/or the QC database may preferably but need not necessarily receive and store, a QC analysis report on whether the aforesaid one or more of the test QC data are outside the corresponding QC parameters.

According to an aspect of one preferred embodiment of the invention, the QC data subsystem may preferably, but need not necessarily, collect the test QC data associated with: (a) a selected one of the users; (b) all of the users of a selected one of the test devices; (c) a selected group, type and/or class of the users; and/or (d) all of the users.

According to an aspect of one preferred embodiment of the invention, the QC data subsystem may preferably, but need not necessarily, collect the test QC data associated with: (a) a selected one of the consumables; (b) a selected shipment of the consumables; (c) a selected lot of the consumables; (d) a selected type of the consumables; and/or (e) all of the consumables.

According to an aspect of one preferred embodiment of the invention, the QC data subsystem may preferably, but need not necessarily, collect a test date as the test QC data, and/or identify an expiration date for the consumables as the corresponding QC parameters.

According to an aspect of one preferred embodiment of the invention, the QC data subsystem may preferably, but need not necessarily, collect an incubation duration as the test QC data.

According to an aspect of one preferred embodiment of the invention, the QC data subsystem may preferably, but need not necessarily, collect the incubation duration by monitoring one or more visual time tracking images associated with the consumables.

According to an aspect of one preferred embodiment of the invention, the QC data subsystem may preferably, but need not necessarily, collect the test QC data by monitoring illumination data associated with the test devices and/or the consumables.

According to an aspect of one preferred embodiment of the invention, the QC data subsystem may preferably, but need not necessarily, monitor the illumination data with reference to one or more intensities, colors, frequencies, positions, and/or numbers of light emitting diodes associated with the test devices.

According to an aspect of one preferred embodiment of the invention, the QC data subsystem may preferably, but need not necessarily, collect the test QC data by monitoring temperature data associated with the test devices and/or the consumables.

According to an aspect of one preferred embodiment of the invention, the QC data subsystem may preferably, but need not necessarily, monitor the temperature data with reference to one or more visual temperature tracking images associated with the consumables.

According to an aspect of one preferred embodiment of the invention, the QC data subsystem may preferably, but need not necessarily, monitor the temperature data with reference to one or more temperature sensors associated with the test devices.

According to an aspect of one preferred embodiment of the invention, the QC data subsystem may preferably, but need not necessarily, collect the test QC data by monitoring humidity data associated with the test devices and/or the consumables.

According to an aspect of one preferred embodiment of the invention, the QC data subsystem may preferably, but need not necessarily, monitor the humidity data with reference to one or more visual humidity tracking images associated with the consumables.

According to an aspect of one preferred embodiment of the invention, the QC data subsystem may preferably, but need not necessarily, monitor the humidity data with reference to one or more humidity sensors associated with the test devices.

According to an aspect of one preferred embodiment of the invention, the QC data subsystem may preferably, but need not necessarily, collect camera data as the test QC data by monitoring one or more working, set-up and/or device conditions associated with the test devices.

According to an aspect of one preferred embodiment of the invention, the QC data subsystem may preferably, but need not necessarily, collect the test QC data by tracking one or more transport conditions and/or delivery timelines associated with the consumables.

According to an aspect of one preferred embodiment of the invention, the QC data subsystem may preferably, but need not necessarily, identify the corresponding QC parameters for authentic ones of the consumables. The QC analysis subsystem may preferably, but need not necessarily, validate the consumables as authentic when the test QC data are within the corresponding QC parameters, and/or identify the consumables as counterfeit when the test QC data are outside the corresponding QC parameters.

According to an aspect of one preferred embodiment of the invention, the QC data subsystem may preferably, but need not necessarily, collect the test QC data from one or more weight sensors onboard the test devices, preferably to determine one or more weights of the consumables at registration time and/or at analysis time.

According to an aspect of one preferred embodiment of the invention, the QC data subsystem may preferably, but need not necessarily, collect the test QC data by monitoring device identification data associated with the test devices.

According to an aspect of one preferred embodiment of the invention, the QC data subsystem may preferably, but need not necessarily, collect the test QC data, and/or identify the corresponding QC parameters, with reference to two or more patient identification images of the consumables. The QC analysis subsystem may preferably, but need not necessarily, register the patient identification images against one another based on one or more affine transformations.

According to an aspect of one preferred embodiment of the invention, the QC improvement data and/or the improved QC procedures may preferably, but need not necessarily, require patient identification images of the consumables to be registered against one another, preferably based on one or more affine transformations.

According to an aspect of one preferred embodiment of the invention, the QC improvement data and/or the improved QC procedures may preferably, but need not necessarily, be based on the test QC data collected by the QC data subsystem.

According to an aspect of one preferred embodiment of the invention, the QC improvement data and/or the improved QC procedures may preferably, but need not necessarily, be based on one or more statistic and/or algorithmic analyses performed by the QC analysis subsystem.

According to an aspect of one preferred embodiment of the invention, the QC improvement data and/or the improved QC procedures may preferably, but need not necessarily, require training and/or certification of one or more of the users.

According to an aspect of one preferred embodiment of the invention, the QC improvement data and/or the improved QC procedures may preferably, but need not necessarily, provide for set-up and/or management of the test devices and/or the consumables.

According to an aspect of one preferred embodiment of the invention, the QC improvement data and/or the improved QC procedures may preferably, but need not necessarily, provide for workflow images to be taken by the test devices at regular intervals.

According to an aspect of one preferred embodiment of the invention, the QC improvement data and/or the improved QC procedures may preferably, but need not necessarily, provide a QC diagnostic application for use by the test devices.

According to the invention, there is also disclosed a quality control (QC) method for use with one or more biological and/or environmental diagnostic test devices, and one or more users and/or consumables. The method includes step (a) of collecting, from the test devices, test QC data associated with at least one of the test devices, the users and the consumables. In step (a), for each respective one of the test QC data, one or more corresponding QC parameters are identified based on the aforesaid at least one. The method also includes step (b) of determining when one or more of the test QC data are outside the corresponding QC parameters. The method also includes step (c) of, when the aforesaid one or more of the test QC data are outside the corresponding QC parameters, generating QC improvement data associated with the aforesaid at least one. The method also includes step (d) of receiving and storing, in a QC database, the QC improvement data for use in improved QC procedures associated with the aforesaid at least one.

According to an aspect of one preferred embodiment of the invention, the QC database may preferably, but need not necessarily, be stored remotely from the test devices.

According to an aspect of one preferred embodiment of the invention, at least part of steps (a), (b) and/or (c) may preferably, but need not necessarily, be each performed remotely from the test devices.

According to an aspect of one preferred embodiment of the invention, in step (a), the test QC data may preferably, but need not necessarily, be collected from and/or associated with: a selected one of the test devices; a selected group of the test devices; and/or all of the test devices.

According to an aspect of one preferred embodiment of the invention, the QC database may preferably, but need not necessarily, be stored onboard a local one of the test devices. The test QC data may preferably, but need not necessarily, be collected from and/or associated with the aforesaid local one.

According to an aspect of one preferred embodiment of the invention, at least part of steps (a), (b) and/or (c) may preferably, but need not necessarily, be each performed substantially local with the QC database and/or onboard the aforesaid local one.

According to an aspect of one preferred embodiment of the invention, the test QC data may preferably, but need not necessarily, be collected from and/or associated with a remote peer group of the test devices.

According to an aspect of one preferred embodiment of the invention, congruent copies of the QC database may preferably, but need not necessarily, be updated and/or stored onboard each of the test devices in the remote peer group.

According to an aspect of one preferred embodiment of the invention, a QC analysis report may preferably, but need not necessarily, be generated in step (b), and be received and/or stored in the QC database in step (d). The QC analysis report may preferably, but need not necessarily, be on whether the aforesaid one or more of the test QC data are outside the corresponding QC parameters.

According to an aspect of one preferred embodiment of the invention, the test QC data collected in step (a) may preferably, but need not necessarily, be associated with: a selected one of the users; all of the users of a selected one of the test devices; a selected group, type and/or class of the users; and/or all of the users.

According to an aspect of one preferred embodiment of the invention, the test QC data collected in step (a) may preferably, but need not necessarily, be associated with: a selected one of the consumables; a selected shipment of the consumables; a selected lot of the consumables; a selected type of the consumables; and/or all of the consumables.

According to an aspect of one preferred embodiment of the invention, in step (a), a test date may preferably, but need not necessarily, be collected as the test QC data, and/or an expiration date for the consumables may preferably, but need not necessarily, be identified as the corresponding QC parameters.

According to an aspect of one preferred embodiment of the invention, in step (a), an incubation duration may preferably, but need not necessarily, be collected as the test QC data.

According to an aspect of one preferred embodiment of the invention, in step (a), the incubation duration may preferably, but need not necessarily, be collected by monitoring one or more visual time tracking images associated with the consumable.

According to an aspect of one preferred embodiment of the invention, in step (a), the test QC data may preferably, but need not necessarily, be collected by monitoring illumination data associated with the test devices and/or the consumables.

According to an aspect of one preferred embodiment of the invention, in step (a), the illumination data may preferably, but need not necessarily, be monitored with reference to one or more intensities, colors, frequencies, positions, and/or numbers of light emitting diodes associated with the test devices.

According to an aspect of one preferred embodiment of the invention, in step (a), the test QC data may preferably, but need not necessarily, be collected by monitoring temperature data associated with the test devices and/or the consumables.

According to an aspect of one preferred embodiment of the invention, in step (a), the temperature data may preferably, but need not necessarily, be monitored with reference to one or more visual temperature tracking images associated with the consumables.

According to an aspect of one preferred embodiment of the invention, in step (a), the temperature data may preferably, but need not necessarily, be monitored with reference to one or more temperature sensors associated with the test devices.

According to an aspect of one preferred embodiment of the invention, in step (a), the test QC data may preferably, but need not necessarily, be collected by monitoring humidity data associated with the test devices and/or the consumables.

According to an aspect of one preferred embodiment of the invention, in step (a), the humidity data may preferably, but need not necessarily, be monitored with reference to one or more visual humidity tracking images associated with the consumables.

According to an aspect of one preferred embodiment of the invention, in step (a), the humidity data may preferably, but need not necessarily, be monitored with reference to one or more humidity sensors associated with the test devices.

According to an aspect of one preferred embodiment of the invention, in step (a), camera data may preferably, but need not necessarily, be collected as the test QC data by monitoring one or more working, set-up and/or device conditions associated with the test devices.

According to an aspect of one preferred embodiment of the invention, in step (a), the test QC data may preferably, but need not necessarily, be collected by tracking one or more transport conditions and/or delivery timelines associated with the consumables.

According to an aspect of one preferred embodiment of the invention, in step (a), the corresponding QC parameters may preferably, but need not necessarily, be identified for authentic ones of the consumables. In step (b), the consumables may preferably, but need not necessarily, be validated as authentic when the test QC data are within the corresponding QC parameters, and/or be identified as counterfeit when the test QC data are outside the corresponding QC parameters.

According to an aspect of one preferred embodiment of the invention, in step (a), the test QC data may preferably, but need not necessarily, be collected from one or more weight sensors onboard the test devices, preferably to determine one or more weights of the consumables at registration time and/or at analysis time.

According to an aspect of one preferred embodiment of the invention, in step (a), the test QC data may preferably, but need not necessarily, be collected by monitoring device identification data associated with the test devices.

According to an aspect of one preferred embodiment of the invention, in step (a), the test QC data may preferably but need not necessarily be collected, and the corresponding QC parameters may preferably but need not necessarily be identified, with reference to two or more patient identification images of the consumables. In step (b), the patient identification images may preferably, but need not necessarily, be registered against one another based on one or more affine transformations.

According to an aspect of one preferred embodiment of the invention, the QC improvement data in steps (c) and/or (d), and/or the improved QC procedures in step (d), may preferably but need not necessarily require patient identification images of the consumables to be registered against one another, preferably based on one or more affine transformations.

According to an aspect of one preferred embodiment of the invention, the QC improvement data in steps (c) and/or (d), and/or the improved QC procedures in step (d), may preferably but need not necessarily be based on the test QC data collected in step (a).

According to an aspect of one preferred embodiment of the invention, in step (b), one or more statistic and/or algorithmic analyses may preferably, but need not necessarily, be performed. The QC improvement data in steps (c) and/or (d), and/or the improved QC procedures in step (d), may preferably but need not necessarily be based on the statistic and/or algorithmic analyses.

According to an aspect of one preferred embodiment of the invention, the QC improvement data in steps (c) and/or (d), and/or the improved QC procedures in step (d), may preferably but need not necessarily require training and/or certification of one or more of the users.

According to an aspect of one preferred embodiment of the invention, the QC improvement data in steps (c) and/or (d), and/or the improved QC procedures in step (d), may preferably but need not necessarily provide for set-up and/or management of the test devices and/or the consumables.

According to an aspect of one preferred embodiment of the invention, the QC improvement data in steps (c) and/or (d), and/or the improved QC procedures in step (d), may preferably but need not necessarily provide for workflow images to be taken by the test devices at regular intervals.

According to an aspect of one preferred embodiment of the invention, the QC improvement data in steps (c) and/or (d), and/or the improved QC procedures in step (d), may preferably but need not necessarily provide a QC diagnostic application for use by the test devices.

According to the invention, there is also disclosed a computer readable medium for use with one or more biological or environmental diagnostic test devices, and one or more users or consumables. The computer readable medium includes executable instructions which are physically stored thereon. The executable instructions, upon execution, encode one or more processors to collect, from the test devices, test quality control (QC) data associated with at least one of the test devices, the users and the consumables. The executable instructions, upon execution, also encode the processors to, for each respective one of the test QC data, identify one or more corresponding QC parameters based on the aforesaid at least one. The executable instructions, upon execution, also encode the processors to determine when one or more of the test QC data are outside the corresponding QC parameters. The executable instructions, upon execution, also encode the processors to, when the aforesaid one or more of the test QC data are outside the corresponding QC parameters, generate QC improvement data associated with the aforesaid at least one. The executable instructions, upon execution, also encode the processors to receive and store, in a QC database, the QC improvement data for use in improved QC procedures associated with the aforesaid at least one.

Other advantages, features and characteristics of the present invention, as well as methods of operation and functions of the related elements of the system, method, and computer readable medium and the combination of steps, parts and economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method, and computer readable medium according to the present invention, as to the structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram of an overall information technology (“IT”) architecture associated with the QC system, method and/or computer readable medium according to the present invention;

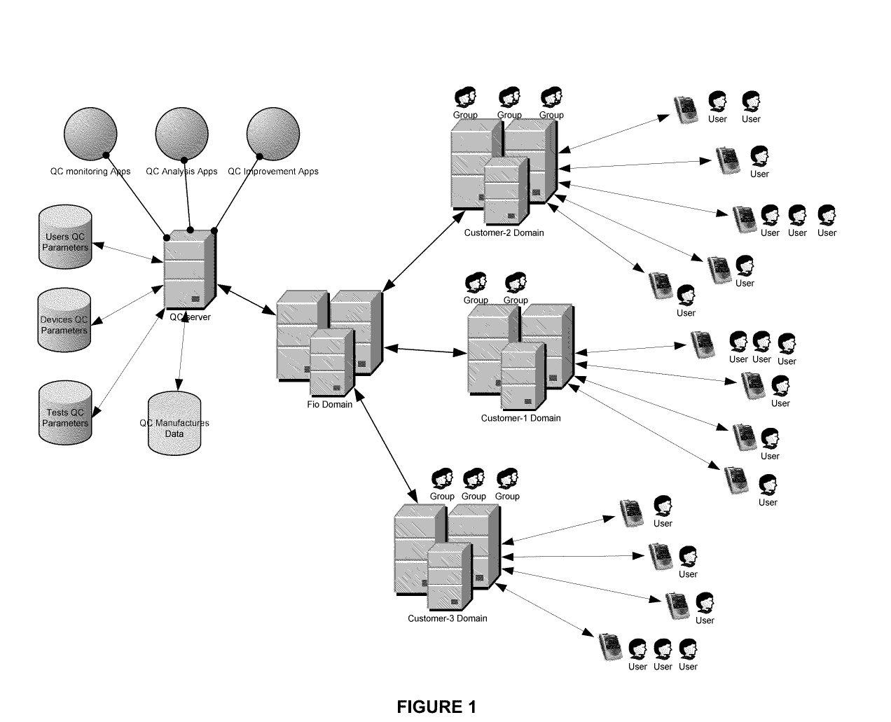

FIG. 2 is a flowchart showing data management features between test devices and a QC server according to the QC system, method and/or computer readable medium of FIG. 1; and

FIG. 3 is a flowchart showing data management features for test devices with onboard QC applications according to the QC system, method and/or computer readable medium of FIG. 1.

### DETAILED DESCRIPTION OF THE PREFERRED EMBODIMENTS

Preferred embodiments of the system, method, and computer readable medium according to the invention are alternately herein referred to, collectively and/or individually, as the QC system, QC method and/or QC computer readable medium (or simply as the system, method and/or computer readable medium). References to one or more of the QC system, method and/or computer readable medium may, if and as appropriate, be understood by persons having ordinary skill in the art to apply, mutatis mutandis, to the others.

As aforesaid, the QC system, method and computer readable medium according to the invention are preferably for use with one or more biological and/or environmental diagnostic test devices, and one or more users and/or consumables. The system includes a QC data subsystem, a QC analysis subsystem, a QC improvement subsystem, and a QC database.

QC Data Subsystem

The QC data subsystem collects, from the test devices, test QC data associated with the test devices, users and consumables. For the test QC data, the QC data subsystem identifies corresponding QC parameters based on the test devices, users and consumables.

The QC data subsystem preferably collects the test QC data from and associated with: (i) a selected one of the test devices, a selected group of the test devices, and/or all of the test devices; (ii) a selected one of the users, all of the users of a selected one of the test devices, a selected group (type and/or class) of the users, and/or all of the users; and/or (iii) a selected one of the consumables, a selected shipment of the consumables, a selected lot of the consumables, a selected type of the consumables, and/or all of the consumables.

The QC data subsystem preferably collects:
a test date as the test QC data, and identifies an expiration date for the consumables as the corresponding QC parameters;
an incubation duration as the test QC data, preferably by monitoring visual time tracking images for the consumables;
the test QC data by monitoring illumination data associated with the test devices and consumables, preferably with reference to the intensities, colors, frequencies, positions, and/or numbers of light emitting diodes onboard the test devices;
the test QC data by monitoring temperature data associated with the test devices and/or the consumables, preferably with reference to: visual temperature tracking images for the consumables; and/or temperature sensors onboard the test devices;
the test QC data by monitoring humidity data associated with the test devices and/or the consumables, preferably with reference to: visual humidity tracking images for the consumables; and/or humidity sensors onboard the test devices;
camera data as the test QC data by monitoring working, set-up and/or device conditions onboard the test devices;
the test QC data by tracking transport conditions and/or delivery timelines for the consumables;
the test QC data from weight sensors onboard the test devices to determine the weight of the consumables at registration time and at analysis time; and/or
the test QC data by monitoring device identification data for the test devices.

QC Analysis Subsystem

The QC analysis subsystem determines when the test QC data are outside the corresponding QC parameters. Preferably, the analysis subsystem generates a QC analysis report on whether the test QC data are outside the corresponding QC parameters.

In some preferred embodiments, the QC data subsystem identifies the corresponding QC parameters for authentic consumables. The analysis subsystem validates the consumables as authentic when the test QC data are within the QC parameters, and identifies the consumables as counterfeit when the test QC data are outside them.

QC Improvement Subsystem

When the test QC data are outside the corresponding QC parameters, the QC improvement subsystem generates QC improvement data associated with the test devices, users or consumables.

QC Database

The QC database receives and stores the QC improvement data for use in improved QC procedures associated with the test devices, users or consumables. Preferably, the QC database also receives and stores the QC analysis report.

i. Remote

In some preferred embodiments, the QC database is stored remotely from the test devices. The QC data subsystem, analysis subsystem, and improvement subsystem are preferably also located remotely from the test devices.

ii. Local

In these and other preferred embodiments, the QC database is stored onboard a local test device. The QC data subsystem preferably collects the test QC data from and associated with the local test device. In some such embodiments, the QC data subsystem, analysis subsystem and improvement subsystem are also preferably substantially local with the QC database and onboard the local test device.

iii. Peer-to-Peer

In these and other preferred embodiments, the QC data subsystem preferably collects the test QC data from and associated with a remote peer group of the test devices. Congruent copies of the QC database are preferably updated and stored onboard each of the test devices in the remote peer group.

Improvements

Preferably, the QC improvement data and the improved QC procedures are based on: the test QC data collected by the QC data subsystem; and/or statistic/algorithmic analyses performed by the QC analysis subsystem.

In some preferred embodiments, the QC data subsystem collects the test QC data, and identifies the corresponding QC parameters, with reference to two or more patient identification images of the consumables. The QC analysis subsystem registers the images against one another based on an affine transformation. In these and other preferred embodiments, the QC improvement data or the improved QC procedures may require the images of the consumables to be registered against one another based on an affine transformation.

Preferably, the QC improvement data and the improved QC procedures may: require training and certification of selected users; provide for set-up and management of the test devices and consumables; provide for workflow images to be taken by the test devices at regular intervals; and/or provide a QC diagnostic application for use by the test devices.

QC Method

Persons skilled in the art will appreciate that although some of the components, relations, functionalities and applications of the system and computer readable medium are not specifically referenced or described in conjunction with the QC method, they may be used or adapted for use in association therewith. The QC method is suitable for use with the system and computer readable medium described herein, but it is not so limited.

Computer Readable Medium

The computer readable medium (e.g., CD-ROM, DVD-ROM, flash USB stick, RAM, ROM, and/or other computer memory device) includes executable instructions which are physically stored thereon and which, upon execution, preferably encode processors to perform the QC method according to the invention.

Further Description

The QC system, method and computer readable medium preferably enable monitoring of QC issues and improve the overall QC with respect to any RDT device, user and consumables.

Preferably, the QC system, method and computer readable medium enable identification of at least three distinct components in conjunction with an ancillary device, interface, system or method: user QC parameters; device QC parameters; and consumable QC parameters.

Preferably, the QC system, method and computer readable medium are based on at least three modules which, based on the data collected, generate at least three distinct types of information: QC monitoring information, such as alerts, QC review dashboard; QC analysis report, such as QC card; and QC improvement data, such as QC training, QC corrective actions.

i. QC Monitoring

Preferably, the QC system, method and computer readable medium provide for at least three levels of device QC monitoring:
local device QC monitoring;
group of devices QC monitoring (e.g., could be split into groups or customer fleets for a service provider's customers); and/or
all device QC monitoring.

Preferably, the QC system, method and computer readable medium provide for at least four levels of users QC monitoring:
individual user QC monitoring;
group of users for the same device QC monitoring;
group of users QC monitoring; and/or
all users QC monitoring.

Preferably, the QC system, method and computer readable medium provide for at least four levels of consumable QC monitoring:
test QC monitoring;
tests box QC monitoring;
lot tests QC monitoring; and/or
global tests QC monitoring.

Preferably, the QC system, method and computer readable medium provide for collection of QC Data:
Expiration date—identify the expiration date on the RDT or be able to use it in an associated database;
Test time—visual time tracking on the consumables, such as, for example, incubation time (e.g., dots, color changes, size, or intensity);
Light—monitoring illumination of the RDTs (e.g., intensity, colors, frequency, position, or number of diodes) and/or adjustment based on type of RDTs;
Temperature—visual temperature tracking on the consumable and/or packaging, and/or on a temperature sensor inside the device;
Humidity—visual humidity tracking system on the consumable and/or packaging and/or on a humidity sensor inside the device;
Camera, working conditions, set-up, and/or device conditions;
Logistic data—such as, for example, transport conditions, timeline(s) for delivery, and/or information concerning counterfeits;
Weight sensor—identification of weight at registration time and/or analysis time;
Affine registration, and/or tracking the link between the RDT and the patient; and/or
RDT identification (“ID”) reader (e.g., RFID and/or barcode reader).
   ii. Analyse QC Data

Preferably, the QC system, method and computer readable medium provide for statistical analysis and/or algorithmic analysis in conjunction with and/or via:
a QC data/analysis module onboard the device;
a server-side QC data/analysis module; and/or
a QC algorithm based on the consumables (e.g., biomarker) and/or manufacturers.
   iii. QC Improvements

Preferably, for each level of QC monitoring, the QC system, method and computer readable medium provide a specific type of QC improvement. The QC improvements are preferably defined, for example, based on the data collected (e.g., as in the non-exhaustive lists hereinbelow), or based on any statistical/algorithmic analysis performed by any QC analysis modules/applications on the server side or inside the device.

A QC improvement module/application may preferably provide various types of functions or features described herein. The QC system, method and computer readable medium preferably provide at least three types of QC improvement.

Preferably, the QC system, method and computer readable medium provide QC improvement functions and/or features as follow:
Affine registration;
User training and user certification;
QC global database;
QC set-up management;
Double readings capabilities—e.g., (remote, live and/or delayed) and/or (Algorithm, Users and/or Expert);
Workflow management (e.g., taking picture every 10 seconds); and/or
QC diagnostic application.

Preferably, the QC system, method and computer readable medium provide types of QC improvement as follow:
QC user improvement;
QC device improvement; and/or
QC consumable improvement.
   iv. Server-Side & Onboard Embodiments

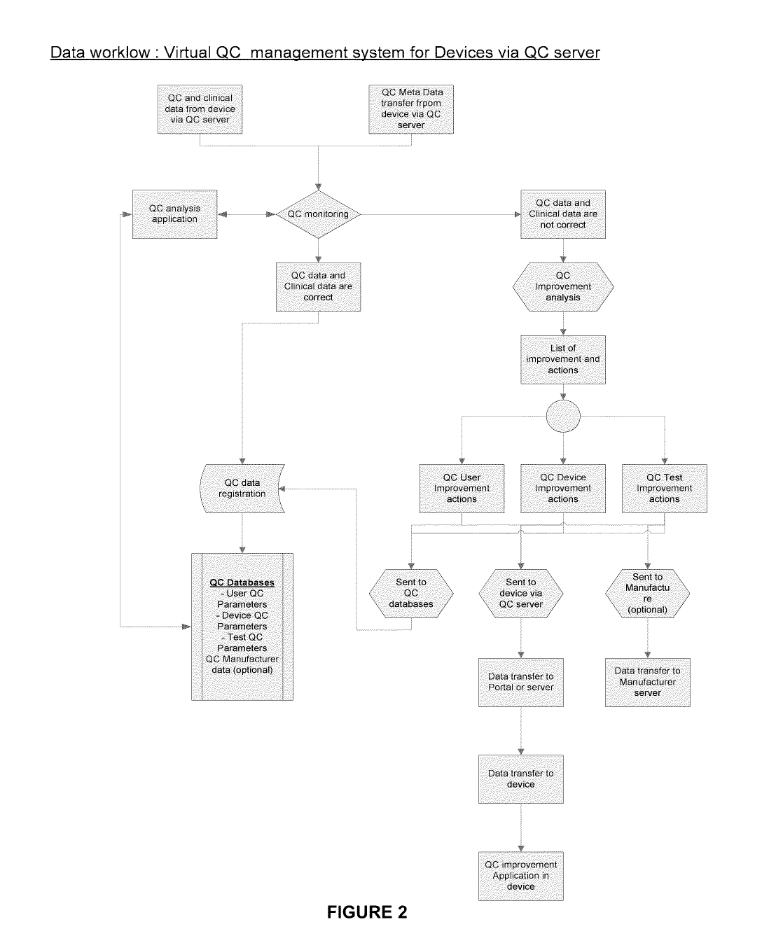

Preferably, the QC system, method and computer readable medium may be used through a QC server. In this case, the data workflow and/or the applications may preferably be hosted by and/or inside a QC server. (See, for example, FIG. 2.)

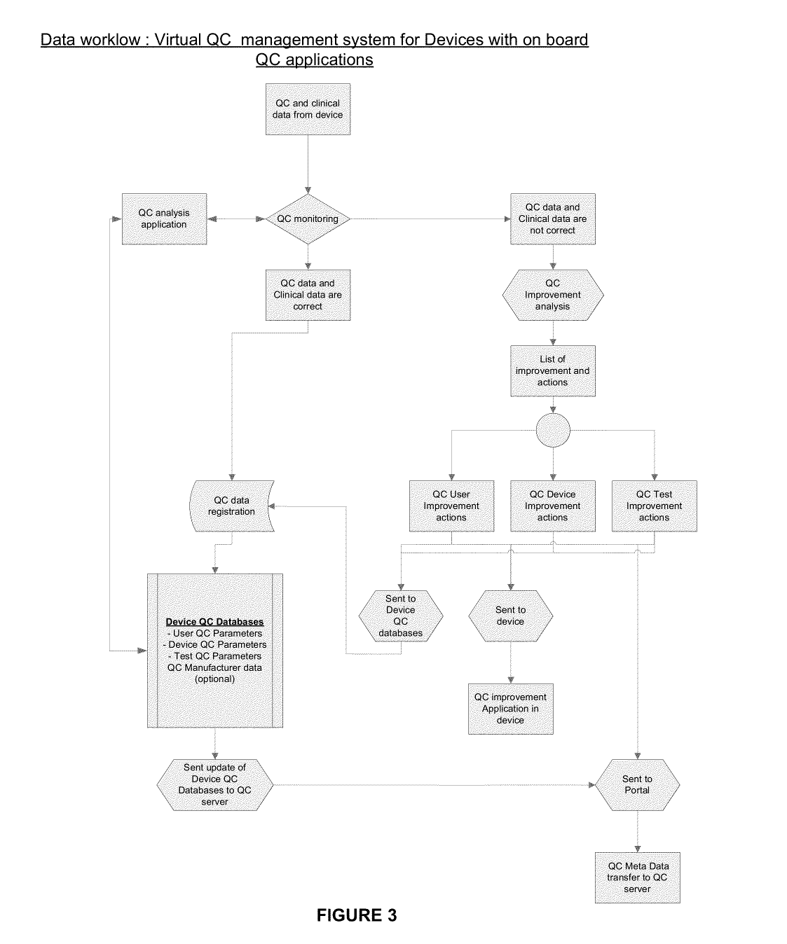

Preferably, the QC system, method and computer readable medium may also, or instead, be used onboard and/or inside the test device. Alternately or in addition, the QC applications may preferably be hosted inside the test device. Updates of the QC databases and/or algorithms may preferably be done periodically, preferably based on user requirements and/or access to a network. (See, for example, FIG. 3.)

Preferably, the QC improvements are sent to the devices and the QC databases.

Preferably, on the device side, the QC improvements may be managed by a QC application and/or directly managed by a service provider application and/or by a diagnostic application onboard.

This concludes the description of presently preferred embodiments of the invention. The foregoing description has been presented for the purpose of illustration and is not intended to be exhaustive or to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by any claims forming a part of this application, and/or the claims of any application claiming priority from this application, and/or any patent issuing thereon.

1-71. (canceled)

72. A quality control (QC) system for use with one or more biological or environmental diagnostic test devices, and one or more users and consumables, wherein the system comprises:
(a) a QC data subsystem which: (i) collects, from the test devices, test QC data associated with the test devices, the users and the consumables, with said QC data subsystem collecting said test QC data from and associated with at least a local one of the test devices; and (ii) for each respective one of said test QC data, identifies one or more corresponding QC parameters based on the test devices, the users and the consumables, such that the QC data subsystem identifies one or more corresponding device QC parameters, user QC parameters, and consumable QC parameters;
(b) a QC analysis subsystem which performs one or more statistic and algorithmic analyses and determines when one or more of said test QC data associated with the test devices, the users and the consumables are outside said corresponding device QC parameters, user QC parameters, and consumable QC parameters, respectively;
(c) a QC improvement subsystem which generates QC improvement data: (i) associated with the test devices, when said test QC data associated with the tests devices are outside the device QC parameters, (ii) associated with the users, when said test QC data associated with the users are outside the user QC parameters, and (iii) associated with the consumables, when said test QC data associated with the consumables are outside the consumable QC parameters; wherein said QC improvement data is based on said test QC data and on said statistic and algorithmic analyses; and
(d) a QC database to receive and store said QC improvement data for use in improved QC procedures associated with the test devices, the users and the consumables; wherein said improved QC procedures are based on said test QC data and on said statistic and algorithmic analyses; and wherein said QC database is stored and updated onboard said local one of the test devices.

73. A system according to claim 72, wherein said QC database is stored remotely from the test devices.

74. A system according to claim 72, wherein at least part of said QC data subsystem, said QC analysis subsystem, and said QC improvement subsystem are located remotely from the test devices.

75. A system according to claim 72, wherein said QC data subsystem collects said test QC data from and associated with: (a) a selected one of the test devices; (b) a selected group of the test devices; or (c) all of the test devices.

76. A system according to claim 72, wherein at least part of said QC data subsystem, said QC analysis subsystem, and said QC improvement subsystem are local with said QC database or onboard said local one of the test devices.

77. A system according to claim 72, wherein said QC data subsystem collects said test QC data from and associated with a remote peer group of the test devices.

78. A system according to claim 77, wherein congruent copies of said QC database are updated and stored onboard each of the test devices in said remote peer group.

79. A system according to claim 72, wherein said QC analysis subsystem generates, and said QC database receives and stores, a QC analysis report on whether said one or more of said test QC data are outside said corresponding QC parameters.

80. A system according to claim 72, wherein said QC data subsystem collects said test QC data associated with: (a) a selected one of the users; (b) all of the users of a selected one of the test devices; (c) a selected group, type or class of the users; or (d) all of the users.

81. A system according to claim 72, wherein said QC data subsystem collects said test QC data associated with: (a) a selected one of the consumables; (b) a selected shipment of the consumables; (c) a selected lot of the consumables; (d) a selected type of the consumables; or (e) all of the consumables.

82. A system according to claim 72, wherein said QC data subsystem collects a test date as said test QC data, and identifies an expiration date for the consumables as said corresponding QC parameters.

83. A system according to claim 72, wherein said QC data subsystem collects an incubation duration as said test QC data.

84. A system according to claim 83, wherein said QC data subsystem collects said incubation duration by monitoring one or more visual time tracking images associated with the consumables.

85. A system according to claim 72, wherein said QC data subsystem collects said test QC data by monitoring illumination data associated with the test devices or the consumables.

86. A system according to claim 85, wherein said QC data subsystem monitors said illumination data with reference to one or more intensities, colors, frequencies, positions, or numbers of light emitting diodes associated with the test devices.

87. A system according to claim 72, wherein said QC data subsystem collects said test QC data by monitoring temperature data associated with the test devices or the consumables.

88. A system according to claim 87, wherein said QC data subsystem monitors said temperature data with reference to one or more visual temperature tracking images associated with the consumables.

89. A system according to claim 87, wherein said QC data subsystem monitors said temperature data with reference to one or more temperature sensors associated with the test devices.

90. A system according to claim 72, wherein said QC data subsystem collects said test QC data by monitoring humidity data associated with the test devices or the consumables.

91. A system according to claim 90, wherein said QC data subsystem monitors said humidity data with reference to one or more visual humidity tracking images associated with the consumables.

92. A system according to claim 90, wherein said QC data subsystem monitors said humidity data with reference to one or more humidity sensors associated with the test devices.

93. A system according to claim 72, wherein said QC data subsystem collects camera data as said test QC data by monitoring one or more working, set-up or device conditions associated with the test devices.

94. A system according to claim 72, wherein said QC data subsystem collects said test QC data by tracking one or more transport conditions or delivery timelines associated with the consumables.

95. A system according to claim 72, wherein said QC data subsystem identifies said corresponding QC parameters for authentic ones of the consumables, wherein said QC analysis subsystem validates the consumables as authentic when said test QC data are within said corresponding QC parameters, and identifies the consumables as counterfeit when said test QC data are outside said corresponding QC parameters.

96. A system according to claim 72, wherein said QC data subsystem collects said test QC data from one or more weight sensors onboard the test devices to determine one or more weights of the consumables at registration time and at analysis time.

97. A system according to claim 72, wherein said QC data subsystem collects said test QC data by monitoring device identification data associated with the test devices.

98. A system according to claim 72, wherein said QC data subsystem collects said test QC data, and identifies said corresponding QC parameters, with reference to two or more patient identification images of the consumables, and wherein the QC analysis subsystem registers said patient identification images against one another based on one or more affine transformations.

99. A system according to claim 72, wherein said QC improvement data and said improved QC procedures require patient identification images of the consumables to be registered against one another based on one or more affine transformations.

100. A system according to claim 72, wherein said QC improvement data and said improved QC procedures require training or certification of one or more of the users.

101. A system according to claim 72, wherein said QC improvement data and said improved QC procedures provide for set-up or management of the test devices or the consumables.

102. A system according to claim 101, wherein said QC improvement data and said improved QC procedures provide for workflow images to be taken by the test devices at regular intervals.

103. A system according to claim 72, wherein said QC improvement data and said improved QC procedures provide a QC diagnostic application for use by the test devices.

104. A quality control (QC) method for use with one or more biological or environmental diagnostic test devices, and one or more users and consumables, wherein the method comprises the steps of:
(a) (i) collecting, from the test devices, test QC data associated with the test devices, the users and the consumables, with said test QC data being collected from and associated with at least a local one of the test devices; and (ii) for each respective one of said test QC data, identifying one or more corresponding QC parameters based on the test devices, the users and the consumables, such that the QC data subsystem identifies one or more corresponding device QC parameters, user QC parameters, and consumable QC parameters;
(b) performing one or more statistic and algorithmic analyses and determining when one or more of said test QC data associated with the test devices, the users and the consumables are outside said corresponding device QC parameters, user QC parameters, and consumable QC parameters, respectively;
(c) generating QC improvement data: (i) associated with the test devices, when said test QC data associated with the tests devices are outside the device QC parameters, (ii) associated with the users, when said test QC data associated with the users are outside the user QC parameters, and (iii) associated with the consumables, when said test QC data associated with the consumables are outside the consumable QC parameters; wherein said QC improvement data is based on said test QC data and on said statistic and algorithmic analyses; and
(d) receiving and storing, in a QC database, said QC improvement data for use in improved QC procedures associated with the test devices, the users and the consumables; wherein said improved QC procedures are based on said test QC data on said statistic and algorithmic analyses; and wherein said QC database is stored and updated onboard said local one of the test devices.

105. A method according to claim 104, wherein said QC database is stored remotely from the test devices.

106. A method according to one of claim 104, wherein at least part of steps (a), (b) and (c) are each performed remotely from the test devices.

107. A method according to claim 104, wherein in step (a), said test QC data is collected from and associated with: a selected one of the test devices; a selected group of the test devices; or all of the test devices.

108. A method according to claim 104, wherein at least part of steps (a), (b) and (c) are each performed local with said QC database or onboard said local one of the test devices.

109. A method according to claim 104, wherein said test QC data is collected from and associated with a remote peer group of the test devices.

110. A method according to claim 109, wherein congruent copies of said QC database are updated and stored onboard each of the test devices in said remote peer group.

111. A method according to claim 104, wherein a QC analysis report is generated in step (b), and received and stored in said QC database in step (d), with said QC analysis report on whether said one or more of said test QC data are outside said corresponding QC parameters.

112. A method according to claim 104, wherein said test QC data collected in step (a) is associated with: a selected one of the users; all of the users of a selected one of the test devices; a selected group, type or class of the users; or all of the users.

113. A method according to claim 104, wherein said test QC data collected in step (a) is associated with: a selected one of the consumables; a selected shipment of the consumables; a selected lot of the consumables; a selected type of the consumables; or all of the consumables.

114. A method according to claim 104, wherein in step (a), a test date is collected as said test QC data, and an expiration date for the consumables is identified as said corresponding QC parameters.

115. A method according to claim 104, wherein in step (a), an incubation duration is collected as said test QC data.

116. A method according to claim 115, wherein in step (a), said incubation duration is collected by monitoring one or more visual time tracking images associated with the consumables.

117. A method according to claim 104, wherein in step (a), said test QC data is collected by monitoring illumination data associated with the test devices or the consumables.

118. A method according to claim 117, wherein in step (a), said illumination data is monitored with reference to one or more intensities, colors, frequencies, positions, or numbers of light emitting diodes associated with the test devices.

119. A method according to claim 104, wherein in step (a), said test QC data is collected by monitoring temperature data associated with the test devices or the consumables.

120. A method according to claim 119, wherein in step (a), said temperature data is monitored with reference to one or more visual temperature tracking images associated with the consumables.

121. A method according to claim 119, wherein in step (a), said temperature data is monitored with reference to one or more temperature sensors associated with the test devices.

122. A method according to claim 104, wherein in step (a), said test QC data is collected by monitoring humidity data associated with the test devices or the consumables.

123. A method according to claim 122, wherein in step (a), said humidity data is monitored with reference to one or more visual humidity tracking images associated with the consumables.

124. A method according to claim 122, wherein in step (a), said humidity data is monitored with reference to one or more humidity sensors associated with the test devices.

125. A method according to claim 104, wherein in step (a), camera data is collected as said test QC data by monitoring one or more working, set-up or device conditions associated with the test devices.

126. A method according to claim 104, wherein in step (a), said test QC data is collected by tracking one or more transport conditions or delivery timelines associated with the consumables.

127. A method according to claim 104, wherein in step (a), said corresponding QC parameters are identified for authentic ones of the consumables; and wherein in step (b), the consumables are validated as authentic when said test QC data are within said corresponding QC parameters, and the consumables are identified as counterfeit when said test QC data are outside said corresponding QC parameters.

128. A method according to claim 104, wherein in step (a), said test QC data are collected from one or more weight sensors onboard the test devices to determine one or more weights of the consumables at registration time and at analysis time.

129. A method according to claim 104, wherein in step (a), said test QC data is collected by monitoring device identification data associated with the test devices.

130. A method according to claim 104, wherein in step (a), said test QC data are collected, and said corresponding QC parameters are identified, with reference to two or more patient identification images of the consumables; and wherein in step (b), said patient identification images are registered against one another based on one or more affine transformations.

131. A method according to claim 104, wherein said QC improvement data in steps (c) and (d), and said improved QC procedures in step (d), require patient identification images of the consumables to be registered against one another based on one or more affine transformations.

132. A method according to claim 104, wherein said QC improvement data in steps (c) and (d), and said improved QC procedures in step (d), require training or certification of one or more of the users.

133. A method according to claim 104, wherein said QC improvement data in steps (c) and (d), and said improved QC procedures in step (d), provide for set-up or management of the test devices and/or the consumables.

134. A method according to claim 133, wherein said QC improvement data in steps (c) and (d), and said improved QC procedures in step (d), provide for workflow images to be taken by the test devices at regular intervals.

135. A method according to claim 104, wherein said QC improvement data in steps (c) and (d), and said improved QC procedures in step (d), provide a QC diagnostic application for use by the test devices.

136. A computer readable medium for use with one or more biological or environmental diagnostic test devices, and one or more users and consumables, with the computer readable medium comprising executable instructions which are physically stored thereon and which, upon execution, encode one or more processors to:
(a) (i) collect, from the test devices, test quality control (QC) data associated with the test devices, the users and the consumables, with said test QC data being collected from and associated with at least a local one of the test devices; and (ii) for each respective one of said test QC data, identify one or more corresponding QC parameters based on the test devices, the users and the consumables, such that the QC data subsystem identifies one or more corresponding device QC parameters, user QC parameters, and consumable QC parameters;
(b) perform one or more statistic and algorithmic analyses and determine when one or more of said test QC data associated with the test devices, the users and the consumables are outside said corresponding device QC parameters, user QC parameters, and consumable QC parameters, respectively;
(c) generate QC improvement data: (i) associated with the test devices, when said test QC data associated with the tests devices are outside the device QC parameters, (ii) associated with the users, when said test QC data associated with the users are outside the user QC parameters, and (iii) associated with the consumables, when said test QC data associated with the consumables are outside the consumable QC parameters; wherein said QC improvement data is based on said test QC data and on said statistic and algorithmic analyses; and
(d) receive and store, in a QC database, said QC improvement data for use in improved QC procedures associated with the test devices, the users and the consumables; wherein said improved QC procedures are based on said test QC data and on said statistic and algorithmic analyses; and wherein said QC database is stored and updated onboard said local one of the test device.
